(19) United States
(12) Patent Application Publication
(10) Pub. No.: US 2016/0033344 A1
(43) Pub. Date: Feb. 4, 2016

(54) STRUCTURAL SHEAR LOAD SENSING PIN

(71) Applicant: Dayton T. Brown, Inc., Bohemia, NY (US)

(72) Inventors: William M. BRADSHAW, St. James, NY (US); Richard L. HARNED, Laurel, NY (US); Stephen H. KELLY, Bluepoint, NY (US); David E. MROCZKA, Babylon, NY (US)

(73) Assignee: DAYTON T. BROWN, INC., Bohemia, NY (US)

(21) Appl. No.: 14/812,506

(22) Filed: Jul. 29, 2015

Related U.S. Application Data
(60) Provisional application No. 62/030,664, filed on Jul. 30, 2014.

(51) Int. Cl. G01L 1/22

(52) U.S. Cl. CPC G01L 1/2225; G01L 1/2262

(57) ABSTRACT

A shear load sensing pin comprising a pin housing having a longitudinal bore therethrough and a strain sensing element disposed in the bore and extending around a complete circumference of an inside wall of the pin surrounding the bore. The strain sensing element extends substantially perpendicular to a longitudinal axis of the pin, so that shear loads can be measured from changes in resistance of the strain sensing element. The strain sensing element can be formed of one or several wires that are wrapped around the circumference of the inside wall of the pin.

### CROSS REFERENCE TO RELATED APPLICATIONS

Applicant claims priority under 35 U.S.C. §119(e) of U.S. Provisional Patent Application Ser. No. 62/030,664 filed on Jul. 30, 2014, the disclosure of which is incorporated by reference.

### BACKGROUND OF THE INVENTION

1. Field of the Invention

The present invention relates to a structural shear load sensing pin. In particular, the invention relates to a pin having an internally located shear load sensor comprised of a sensor element that extends perpendicular to the longitudinal axis of the pin.

2. The Prior Art

Various methods have been used to measure strain on load carrying components such as bolts or attachment pins. One method is to use metallic strain gauges on the load carrying components.

The metallic strain gage consists of a very fine wire or, more commonly, metallic foil arranged in a grid pattern. The grid pattern maximizes the amount of metallic wire or foil subject to strain in the parallel direction. The cross-sectional area of the grid is minimized to reduce the effect of shear strain and Poisson Strain. The grid is bonded to a thin backing, called the carrier, which is attached directly to the test specimen. Therefore, the strain experienced by the test specimen is transferred directly to the strain gage, which responds with a linear change in electrical resistance. Many common applications utilize several small strain gages distributed over surface of the component, or in a hollow inner diameter, to measure strain at several specific locations. These readings are then correlated to the load on the member by subjecting the component to known loads and obtaining a set of strain readings. Then, regression analysis or other mathematical techniques are used to develop equations for the component load based on a given set of strain readings.

The difficulty with the practical application of this method is the variability of the various strain readings when the pin moves, either translation or rotation, relative to the joint or the joint components move relative to the pin. Additionally, wear between the pin and the joint members will change the readings. Any difference between the in service joint conditions and the carefully controlled conditions under which the pin was calibrated, will change the strain readings and cause inaccuracies in the load measurement. Such small movements are typical in joints where the components being joined are required to move to allow free movement of the components, such as aircraft landing gear.

A single strain sensing element is used in U.S. Pat. No. 2,873,341 to Kutsay. This element is in the form of a resistance wire that is wrapped around the inside of cavity in a pin and is used to measure longitudinal strain on the pin. The wire extends generally longitudinally, so longitudinal strain will cause stress on the wire and change its resistance. This arrangement cannot be used to detect shear on the pin, however, due to the longitudinal arrangement of the wires.

Attempts to use the arrangement of Kutsay or of other longitudinally arranged strain sensors create inaccuracies in load determination due the fact these gauges are measuring strains due to bending of the pin, not measuring shear load directly. Bending moment is a function of shear load and of the load's location. As the joint's geometry changes, the bending moment changes and thus the strain readings of the axially aligned strain gages also change.

Shear strain gages consisting of a pair of strain gages oriented at +/−45 degrees from the pins axis have also been utilized for measuring shear loads. These gages are typically located at the nominal plane of maximum shear load in the joint, at the plane between the loading and reacting components attached to the pin. The problem with this method is that the shear strain is highly variable with location both along the axis of the pin and around the circumference. U.S. Pat. No. 3,695,096 to Kutsay addresses this problem by utilizing a circumferential groove on the outer diameter of the pin, between the components loading the pin, to ensure that all load is applied, or reacted, on one side or the other of the shear gages. However, such grooves induce stress concentrations and reduce the pins strength, which is unacceptable in many applications such as aircraft landing gear.

### SUMMARY OF THE INVENTION

It is therefore an object of the invention to provide a strain gauge to measure shear strain on a pin or bolt, which is simple to use and install and which can compensate for small movements of the pin without sacrificing accuracy.

These and other objects are accomplished by a shear load sensing pin comprising a pin housing having a longitudinal bore therethrough and a strain sensing element disposed in the bore and extending around a complete circumference of an inside wall of the pin housing surrounding the bore. The strain sensing element extends substantially perpendicular to a longitudinal axis of the pin, so that shear loads can be measured from changes in resistance of the strain sensing element.

In one embodiment, the strain sensing element comprises at least one wire that is wrapped around the circumference of the inside wall of the pin housing surrounding the bore. The strain sensing element preferably a single wire arranged in a parallel grid pattern, so that the wire extends along the strain sensing element up and back several times. The strain sensing element can be configured so that it extends along a substantial portion of the length of the bore. Shear strain on the wire causes strain in the longitudinal direction of the wire, which changes its resistance. The change in resistance is measured to assess the amount of shear strain on the pin.

In another embodiment, the wire is wrapped helically around the inner wall of the pin housing so that the wire extends around the circumference of the bore at least two and preferably three times. In another embodiment, there are a plurality of parallel wires or a single wire arranged in an up-and-back grid pattern, that are helically wrapped around the inner wall of the housing so that the area covered by the wires increases.

The wire is preferably made of a material that has a large variation in resistance under strain. For example, one suitable material is Constantin, a copper-nickel alloy that has a high strain sensitivity and low temperature sensitivity.

In order to measure the shear load on the pin, the sensor element is connected to a Wheatstone bridge circuit or other measuring device that measures changes in resistance of the sensor element. The connection could be made by electrical cables or wirelessly by the use of a transmitter in the bore.

The pin is used to connect two structural elements that exert a shear force on the pin. The strain sensing elements are useful to determine how much shear strain is being exerted and if the pin is in danger of damage or of coming loose.

This device is especially useful in measuring shear loads connecting components that require movement to operate. An example would be aircraft landing gears that are extended for landing but are stowed inside the aircraft for flight. Such joints have gaps between the members connected by the pin to allow such movement and these gaps are subject to change under normal operation as part of their design to allow free movement.

### BRIEF DESCRIPTION OF THE DRAWINGS

Other objects and features of the present invention will become apparent from the following detailed description considered in connection with the accompanying drawings. It is to be understood, however, that the drawings are designed as an illustration only and not as a definition of the limits of the invention.

In the drawings, wherein similar reference characters denote similar elements throughout the several views:

FIG. 1 shows a typical strain gauge as is commonly used in the art;

FIG. 2 shows a view of one embodiment of the pin according to the invention connecting two structural elements;

FIG. 3 shows another view of the pin according to FIG. 2; and

FIG. 4 shows another embodiment of the pin according to the invention.

The pin is shown transparent in these views for ease of illustration.

### DETAILED DESCRIPTION OF THE PREFERRED EMBODIMENT

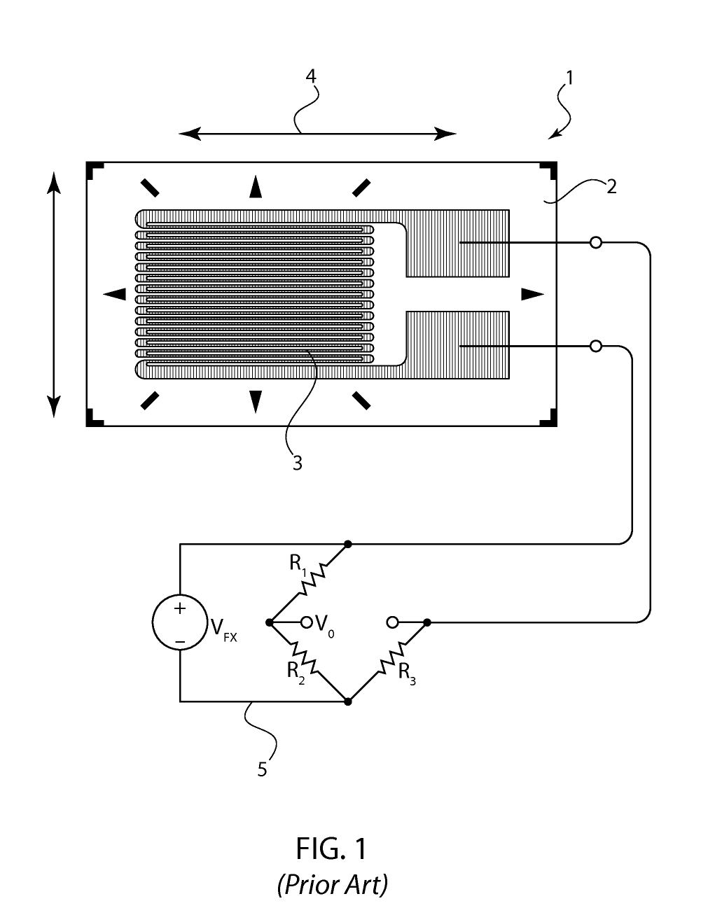

Referring now in detail to the drawings, FIG. 1 shows a strain gauge 1 that is commonly used in the art. Strain gauge 1 is comprised of a foil backing 2 onto which a wire 3 is arranged in a grid of parallel lines. Two contacts 4 extend out from foil 2 and allow connection of wire 3 to a measurement device such as a Wheatstone bridge circuit 5. Strain in the direction of arrow 4 increases the resistance of wire 3, which is then measured by the circuit 5 to assess the amount of strain on the object to which foil 2 is placed.

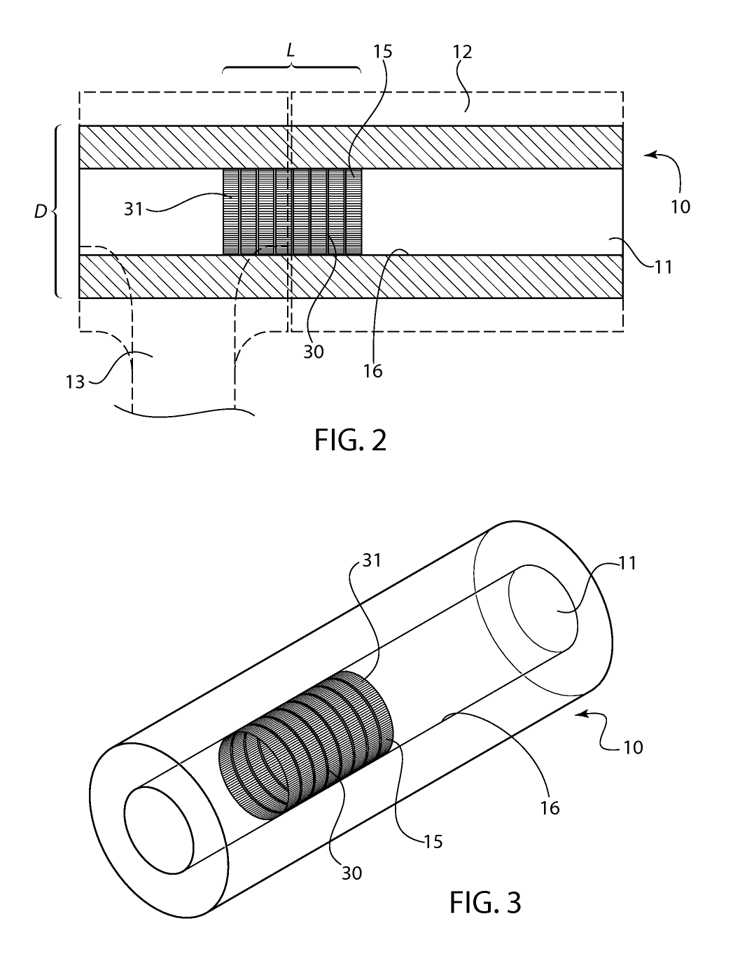

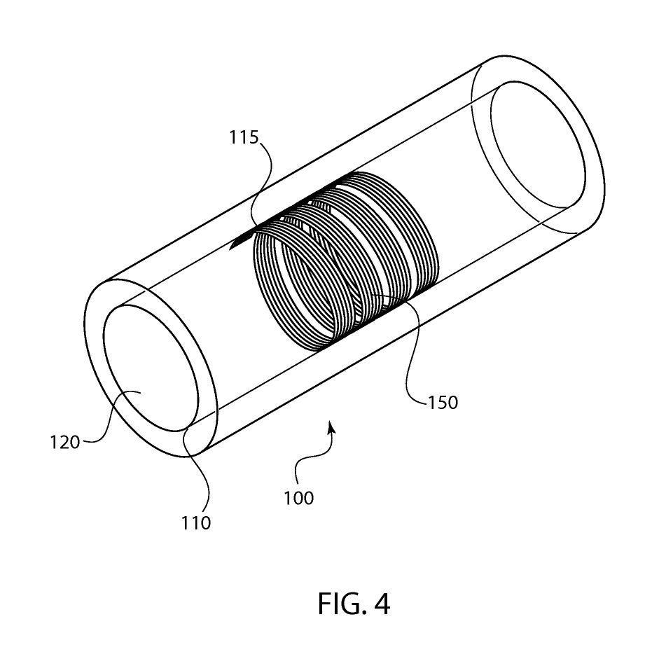

FIGS. 2 and 3 show a cylindrical pin 10 according to the invention. Pin 10 has a bore 11 therethrough. Pin 10 is used to connect two structural components 12, 13, shown here in broken lines. Disposed within bore 11 is a strain sensing element 15 disposed circumferentially around an inner wall 16 of pin 10, surrounding bore 11. Pin 10 is shown transparent in these Figures for ease of illustration. In practical use, pin 10 is formed of metal and strain sensing element 15 is not visible.

Strain sensing element 15 is formed of a wire 30 arranged in a grid, as described above with respect to FIG. 1, so that the single wire extends up and back several times across the strain sensing element 15. More than 1 strain sensing element 15 can be used in a single pin, arranged next to each other. Wire 30 can be applied to a foil 31 which is then applied to pin 10, or can be applied directly to pin 10 via adhesive. Each strain sensing element 15 extends around a full circumference of the inside of pin 10. Preferably, the length L of the area covered by strain sensing element 15 is at least as large as the diameter D of pin 10. Strain sensing element 15 is preferably placed so that the area covered by strain sensing element 15 spans the junction between the two structural components 12, 13. Shear strain applied to pin 10 puts longitudinal strain on wire 30, which increases its resistance. The wire 30 of strain sensing element 15 is preferably formed of a metal that is resistance sensitive, i.e., the resistance of the metal changes measurably in response to stress placed on the metal. One example of a suitable material is Constantin. As described with respect to FIG. 1, strain sensing element 15 is connected to a measuring device (not shown) such as a Wheatstone bridge circuit or other suitable device, via cables, or can be configured wirelessly, in a manner such as described in U.S. Pat. No. 8,024,980 to Arms, the disclosure of which is herein incorporated by reference.

An alternative embodiment of the invention is shown in FIG. 4. Here, pin 100 has a bore 120 and a strain sensing element 150 that is configured of a single wire 115 arranged in a grid pattern as described above. The entire strain sensing element 150 is then wound helically around inside wall 110 of pin 100 so that strain sensing element 150 can cover a large surface area of pin 100. As with the embodiment of FIGS. 2 and 3, strain sensing element 150 can be connected to a measuring device either wirelessly or via cables.

Accordingly, while only a few embodiments of the present invention have been shown and described, it is obvious that many changes and modifications may be made thereunto without departing from the spirit and scope of the invention.

What is claimed is:

1. A shear load sensing pin comprising:
a pin housing having a longitudinal bore therethrough;
a strain sensing element disposed in the bore and extending around an complete circumference of an inside wall of the pin housing surrounding the bore, the strain sensing element extending substantially perpendicular to a longitudinal axis of the pin.

2. The shear load sensing pin according to claim 1, wherein the strain sensing element comprises at least one wire extending along a length of the strain sensing element so that the wire extends substantially perpendicular to a longitudinal axis of the pin.

3. The shear load sensing pin according to claim 2, wherein the wire is arranged in a grid that extends along a length of the strain sensing element several times.

4. The shear load sensing pin according to claim 2, wherein the strain sensing element is wrapped helically around the inner wall of the pin housing so that the strain sensing element extends around the circumference of the bore at least two times.

5. The shear load sensing pin according to claim 4, wherein the wire is arranged in a grid that traverses a length of the strain sensing element several times.

6. The shear load sensing pin according to claim 2, wherein the at least one wire is made of Constantin.

7. The shear load sensing pin according to claim 1, wherein the strain sensing element is connected to a Wheatstone bridge circuit that measures changes in resistance of the sensor element.

8. The shear load sensing pin according to claim 2, wherein the wire is applied to a foil that is attached to the inside wall of the pin.
